(19) United States
(12) Patent Application Publication
(10) Pub. No.: US 2007/0272733 A1
(43) Pub. Date: Nov. 29, 2007

(54) PRINTED PUBLICATION WITH A READABLE CODE FOR CONNECTION TO A COMPUTING DEVICE

(76) Inventor: Donald Spector, New York, NY (US)

Correspondence Address: DIEHL SERVILLA LLC, 77 BRANT AVE, SUITE 210, CLARK, NJ, 07066, US

(21) Appl. No.: 11/683,160

(22) Filed: Mar. 7, 2007

Related U.S. Application Data
(63) Continuation-in-part of application No. 11/440,934, filed on May 25, 2006.

(51) Int. Cl. G06F 17/00; G06K 19/06; G06K 7/00

(52) U.S. Cl. 235/375; 235/435; 235/494

(57) ABSTRACT

A printed publication, such as a book, with a connection is provided. The printed publication has one or more readable codes associated with it which can be read by a scanner or other reader. The scanner provides a connection, preferably via a wireless standard, to a computer. The computer, cell phone, pda or any wi fi system contains software that can decode and relay the information to a platform targeting the proper hyperlinks or directly to those hyperlinks in response to the code can display other the master platform or specific websites.

### STATEMENT OF RELATED CASES

This application is a continuation-in-part of U.S. patent application Ser. No. 11/440,934, filed May 25, 2006, which is hereby incorporated by reference.

### FIELD OF THE INVENTION

This application relates to the field of books and to educational systems and methods.

### BACKGROUND OF THE INVENTION

Learning from a text book can be difficult and limiting. People learn through different mechanisms. Some people simply read and remember, others need to take copious notes from a text book to learn. Others learn better through visual and pictorial presentations of information. A simple text book does not offer a full range of teaching mechanisms that can be helpful to students. Also, it can be difficult to organize all of the additional references or information obtained from sources other than the textbook.

Long distance educational systems and methods can also be difficult to implement. It is difficult to track the progress of various students.

Accordingly, new and improved books and educational systems and methods are needed.

### SUMMARY OF THE INVENTION

In accordance with one aspect of the present invention a printed publication is provided. The printed publication includes a plurality of pages and an optically readable code located on the printed publication, the optically readable code encoding one or more hyperlinks to Internet sites. Further, the optically readable code can encodes additional information relating to the subject matter of the book, as further described herein.

The printed publication can be a book or a magazine. It can also be any other information bearing publication.

In accordance with a further aspect of the present invention, a plurality of optically readable codes can be located on the printed publication. The optically readable codes can be provided on one or more pages of the printed publication. They can also be located on a cover of the printed publication.

The printed publication can also be organized into a plurality of chapters, wherein each of the plurality of chapters. One of the optically readable codes can be associated with each of the plurality of chapters. The code can be encoded with a hyperlink relevant to the chapter the code is associated with.

The optically readable codes can be bar codes. Any of the many known bar codes can be used. Further, any other type of optically readable code can be used.

In accordance with a further aspect of the present invention, the optical reader can be connected to a computer. The optical reader reads the optically readable code, decodes the hyperlink information or other information encoded in the code. The decoded information is transmitted to the computer.

In accordance with another aspect of the present invention, the optical reader is connected to the computer through a transmitter and a receiver. The transmitter and receiver preferably provide wireless communication in accordance with any known standard, such as Bluetooth, ir or microwave.

The present invention also provides a method of conveying information through a printed publication having a plurality of pages. As previously described, the method includes locating an optically readable code on the printed publication, the optically readable code encoding one or more hyperlinks to Internet sites or to a platform abstracting or connecting to those sites as well as the aspects previously described.

Various other implementations as discussed herein are also contemplated.

### DESCRIPTION OF THE DRAWINGS

FIGS. 1 and 2 illustrate one aspect of the present invention.

FIG. 3 illustrates the use of a platform to access the Internet in accordance with another aspect of the present invention.

FIGS. 4 to 11 illustrate various other aspects of the present invention.

### DESCRIPTION OF A PREFERRED EMBODIMENT

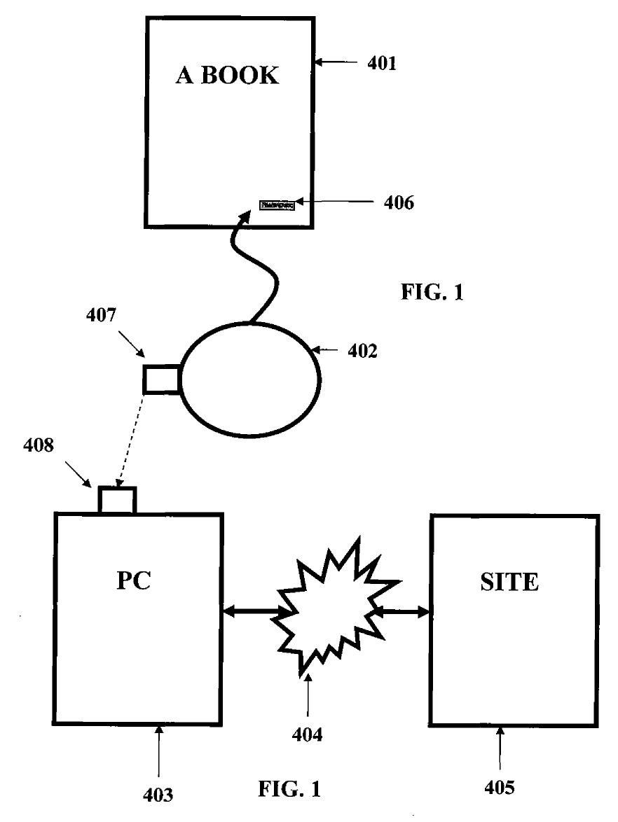

Referring to FIG. 1, a printed publication 401 having a plurality of pages is illustrated. The printed publication 401 can be a book, a magazine or any other printed publication. The printed publication 401 communicates with a reader 402, a computer 403, the internet 404 and one or more sites 405 on the internet. The printed publication 401 has a readable code 406 located on it. The readable code 406 encodes an address to one or more Internet sites or for use by a platform that contains hyperlinks to such sites. It can also encode other information, as described herein, including further information relating to the printed publication 401 or executable programs to be executed by a processing device.

The computer 403 can be any type of processing device. By way of example only, the device 403 can be a personal computer, a laptop computer, a cell phone, a personal digital assistant or any other type of processing device.

The readable code 406 is preferably, but not necessarily, an optical code. The readable code 406 can be, for example, a bar code. The readable code 406 can also be any other type of code. The reader 402 used depends on the form of the readable code 406. For example, if the readable code 406 is optical, then an optical reader 402 is used.

In accordance with one aspect of the present invention, the reader 402 is placed over the readable code 406 to read the code 406. The reader 402 transmits the information from the readable code 406 via a transmitter 407 to a receiver 408 at the computer 403. The reader 403 can be a button type reader where it is placed over the code 406. It can also be shaped like a wand and scanned over the readable code 406. Readers of these types are well known.

As described herein, the printed publication 401 can be any type of printed publication, including but not limited to a book. The readable code 406 can be located anywhere on the printed publication, including on the cover and on pages of the printed publication. Additionally, one or more readable codes 406 can be provided on the printed publication.

The readable code 406, in accordance with one aspect of the present invention, encodes an address to an Internet website 405. The readable code 406 can also encode addresses to a plurality of Internet websites.

In accordance with a further aspect of the present invention, the readable code 406 represents a hyperlink to an Internet website 405. The hyperlink can be read by the processing device 403 and used to access the Internet website 405 when the code 406 is transmitted by the reader 402 to the processing device 403. In accordance with one aspect of the present invention, the processing device 403 can automatically access the Internet website 405 specified by the hyperlink upon reception of the hyperlink. Alternatively, the processing device 403 can display a menu and allow a user to request that the specified Internet website 405 be accessed.

In accordance with another aspect of the present invention, the readable code 406 can encode a plurality of hyperlinks. These plurality of hyperlinks can be transmitted to the processing device 403 which can display each of the plurality of hyperlinks as an option for a user to select. The processing device 403 would then access the selected Internet site.

In accordance with another aspect of the present invention, the readable code 406 can specify a code to be read by a platform device. The platform device receives the codes from printed publications and uses these codes to access a platform to determine which Internet websites to access. The platform can be updated by third parties, such as publishers of the printed publication so that current information can always be provided. Thus, even if a printed publication is old, the information available through the present invention is always current. This way, a publisher can even provide information about updates, reprints and new editions. A publisher can also provide information related to the subject matter of the printed publication 401. For example, the publisher can store additional information relating to the subject matter of the printed publication 401, such as additional sources of information, other related information not in the printed publication, advertising information and the like. The publisher could also provide an audio file of the printed publication which could be read from the platform.

The platform device can be the processing device 403, such as a personal computer. In accordance with one aspect of the present invention, a code is transmitted to the processing device 403. The processing device 403 reads the code and accesses a data structure to determine hyperlinks associated with the code. Other information can be associated with the hyperlinks as well. The processing device 403 can use the hyperlink information in the data structure to access Internet websites 405. The access can be automatically upon receipt of the code, or can be accomplished after displaying a menu on the processing device 403 to allow a user to select an Internet website 405 to access. Where multiple hyperlinks are associated with a code, it is preferred to display a menu to allow the user to select the desired site.

Any data structure can be used by the platform to maintain the information associated with a code. Tables, look-up tables, databases, other memory structures or software can be used to maintain this information. As previously described, this information can be updated by the publishers of the printed publication or by their designees.

The transmitter 407 and the receiver 408 are preferably wireless. They preferably communicate with one of the known wireless standards, such as Bluetooth. Any wireless standard, however, can be used to provide the communications.

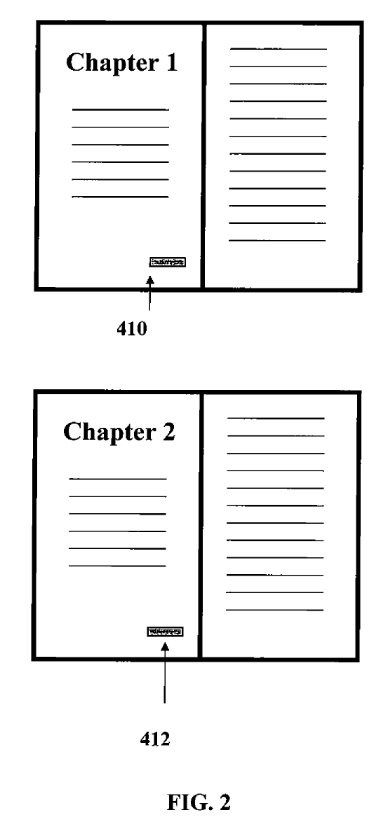

Referring to FIG. 2, several pages of a book are illustrated. The book has a plurality of chapters. Chapter 1 and 2 are shown. An optically readable code 410 is associated with Chapter 1 and another optically readable code 412 is associated with Chapter 2. The optically readable code 410 provides hyperlinks and/or information relating to the subject matter of chapter 1 and the optically readable code 412 provides hyperlinks and/or information relating to the subject matter of chapter 2. For example, if the book is a text book, the codes 410 and 412 can provide a hyperlink to homework problems related to the chapter and another hyperlink (or the same hyperlink) to a test related to the chapter. Alternatively, each code 410 and 412 can provide codes to a platform that reads the codes to determine what hyperlink to go to or can specify additional information related to each chapter.

Thus, the code embodied in the readable code 406 can be a simple hyperlink to a platform on the internet which recognizes the code and redirects it to the appropriate site on the internet or a hyperlink connected directly or added onto the platform, that has further links to information related to the subject matter of the printed publication. The computer reading the code, in response to the code, can access other websites and other programs. For example, there can be links to other web sites that contain further visual and audio content, to advertisers who sell related products or services, and to any other relevant information. Links can also be provided to educational sites associated with the printed publication that provide homework assignments and tests, by way of example only. Thus, online courses can greatly benefit from this approach. Providing a hyperlink to all of the information thus has the advantage of allowing the information links to be updated on a regular basis, so that the code on the printed publication always has meaning.

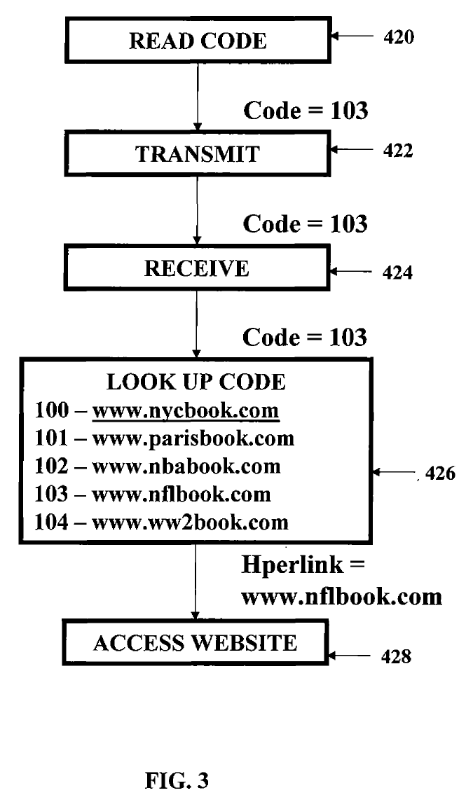

FIG. 3 illustrates the use of a platform in accordance with one aspect of the present invention. In step 420, the reader 402 reads the code 406. In this case, it reads a code, for example, 103. In step 422, the reader 402 transmits the code. In step 424, the code is received at the processing device 403. In step 426, the processing device 403 accesses a data structure, such as a look up table, with the code 103. The table indicates a hyperlink of www.nflbook.com. In step 428, the processing device 403 uses the hyperlink associated with code 103 to access the related Internet website.

This system and method can be used to provide additional information related to the subject matter in a printed publication. By way of example, only an educational system can be provide, advertising information can be provided, and other information can be provided.

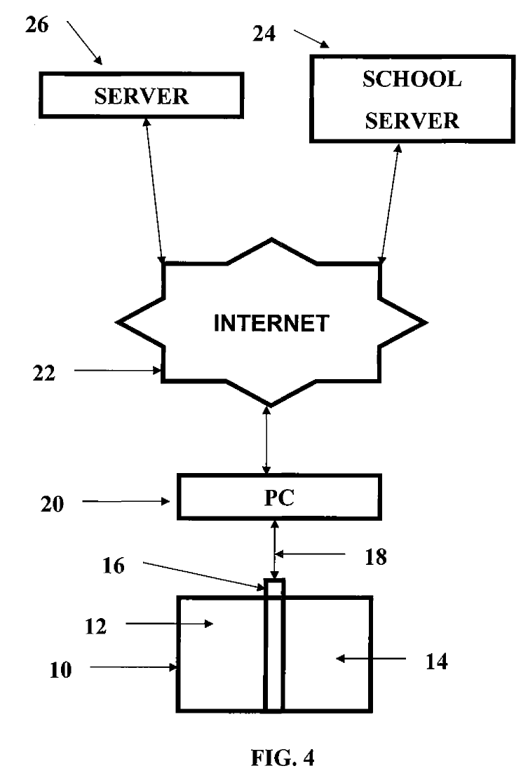

FIG. 4 illustrates an education system in accordance with a further aspect of the invention. In this embodiment, the system includes a book 10 having a left side 12, a right side 14 and a spine 15. A connector 16 is attached to the book 10, preferably on the spine 15 of the book 10, although it can be attached anywhere on the book 10.

The connector 16 can be a USB connector. While the connection can be provided by a cable or by other means, it is preferable to provide the connection via a wireless transmitter and receiver, as described above.

A cable 18 can also connect the book 10 to a personal computer 20. The personal computer 20 is connected to a network, such as the internet 22. A plurality of servers 26 are connected to the internet 22. A school's server 24 is also connected to the internet 22. Thus, the servers 24 and 26 are connected to the book 10 through the internet 22 and the personal computer 20.

Any type of connector 16 can be used. For example, the connector 16 can be a wireless transceiver that connects to a personal computer 20. While the connection—by wire or wireless—can be made directly to the personal computer 20, it can also connect to another personal computer via the internet 22 or to any server 26 on the internet.

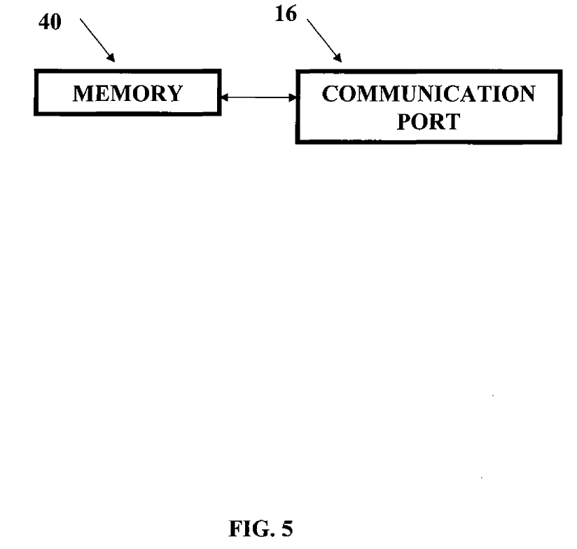

FIG. 5 illustrates a circuit that can be located on the book 10 in accordance with one aspect of the present invention. The book 10 preferably has a memory 40 that is connected to a connector or communication port 16. In accordance with one aspect of the present invention, one or more documents related to the contents of the book are stored in the memory 40.

The memory 40 can also be located on the spine 15 of the book 10. The memory 40 and the connector 16 can be attached by an adhesive or by other means. For example, the memory 40 and the connector 16 can be attached inside a cover of the book 10 by adhesive. The can also be attached to a special page or to an insert during the manufacturing process.

The one or more documents can include a worksheet related to the book 10. They can also include problems related to the book. They can also include notes related to the book. Typically, the notes are generated by a user on a personal computer 20 when the user is reading the book or other sources and the notes can be stored on the memory 40 of the book 10. The notes can be stored as a template in the memory 40 for use by a user.

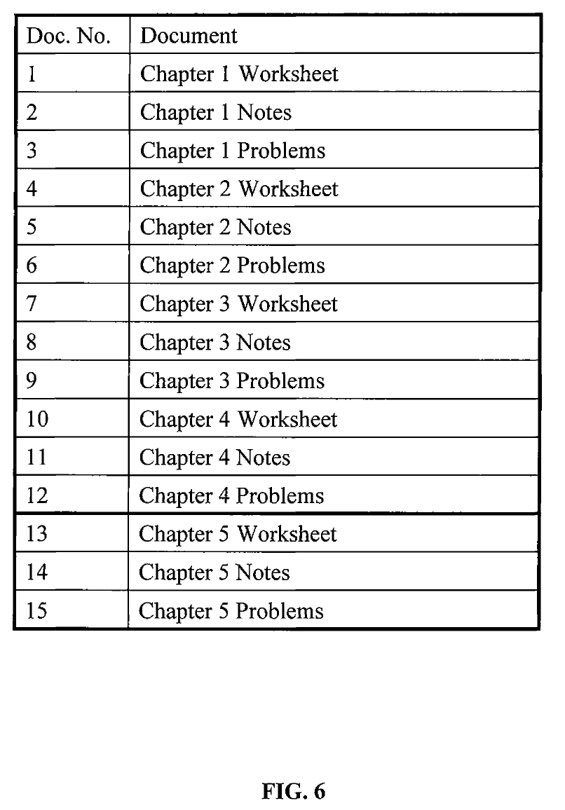

An example of the one or more documents stored on the memory 40 is illustrated in FIG. 6. There are fifteen documents stored on the memory. The first document is a worksheet based on the contents of chapter 1 in the book 10. The worksheet is a programmed review of the contents of chapter 1. The second document is notes from chapter 1 of the book 10. The document can be a blank document or it can be in template form. The notes document can be modified by a user, typically on the personal computer 20 and then stored on the memory 40 of the book 10 in a modified form. The third documents are problems related to the contents of chapter 1 of the book 10. Documents 4 to 15 are similar documents relating to chapters 2 to 5 of the book 10.

The documents from the memory 40 on the book 10 can be used, manipulated and modified by an owner of the book 10 while studying the book. Typically, the owner would use the documents on the personal computer 20 and store the documents, as modified, on the memory 40 in the book 10.

The documents can also be sent by the personal computer 20 to the school server 24 once they are completed by an owner of the book 10. The school server 24 can check on the progress of the book owner. If the book owner is a student in a class at the school, the school can conduct effective long distance learning by checking the progress of the book owner.

Each of these documents, as well as the other documents and functionality specified throughout this specification, can be provided through a code encoded on an optically readable code on the book that specifies a hyperlink to a website that includes these documents.

Each of these documents and the table illustrated can be provided on a platform, such as the processing device 403, as previously described. When a code is read, it directs the

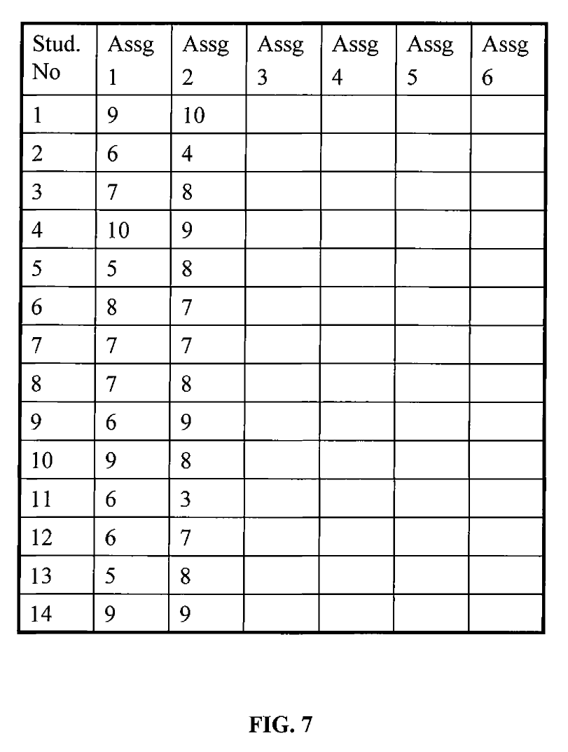

FIG. 7 illustrates a database maintained by the school server 24. The school server 24 can track the progress of a number of students in accordance with the present invention. In FIG. 7, there are fourteen students being tracked. During a semester, there will be six assignments, which could include homework, tests, worksheets, problem sets and the like. The first two assignments have been completed and every student has submitted a document through a personal computer 20 to the school server 24. Grades have been entered into the database of FIG. 7 for each student for each of the first two assignments. In this fashion, the progress of the students can be tracked by the school server 24.

The school server 24 can also submit documents to be stored on the memory 40 of the book 10. The server 24 would typically first transmit the documents to the personal computer 20, which would then transmit the documents to the memory 40 on the book 10. These documents could be comments from a teacher, progress reports or other communications to the student or owner of the book 10.

The owner of the book 10 can also connect to other servers 26 via the internet 22 to obtain further information about the subject of the book 10. The memory 40 may include a listing of sites and a link to those sites so that the book owner can easily access the sites by clicking on a document that has been transmitted from the memory 40 on the book 10 to the personal computer 20. The documents from various servers 26 can also be stored on the memory 40 of the book 10.

The processing device 403 can maintain this database or can communicate with the service maintaining the database and provide this information to a user.

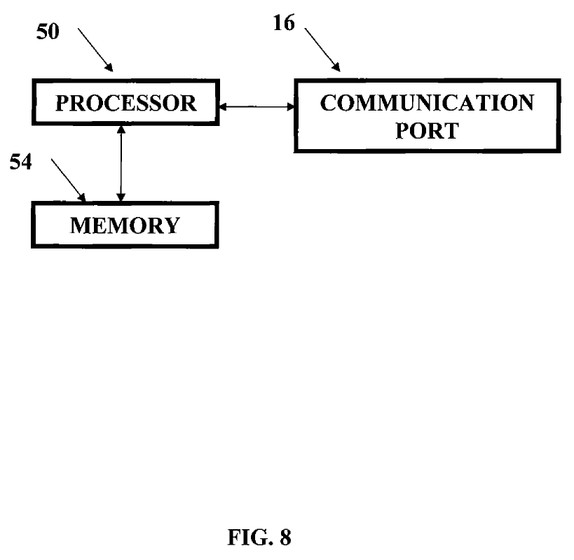

FIG. 8 illustrates another embodiment of a circuit that may be found on the book 10. This circuit includes the communication port 16 which is preferably a USB port. It also includes a processor 50 connected to the port 16 and a memory 54 connected to the processor 50. The memory 54 can store the previously referred to documents. It can also store application software that can be accessed by the processor 50. The application software can be downloaded to the personal computer 20 or processed by the processor 50. The memory 40 from FIG. 5 can also hold application software that can be downloaded to the personal computer 20.

The processor 50 is preferably located near the memory 54 and the connector 16. These components can be located in the same places as previously discussed with respect to the memory 40.

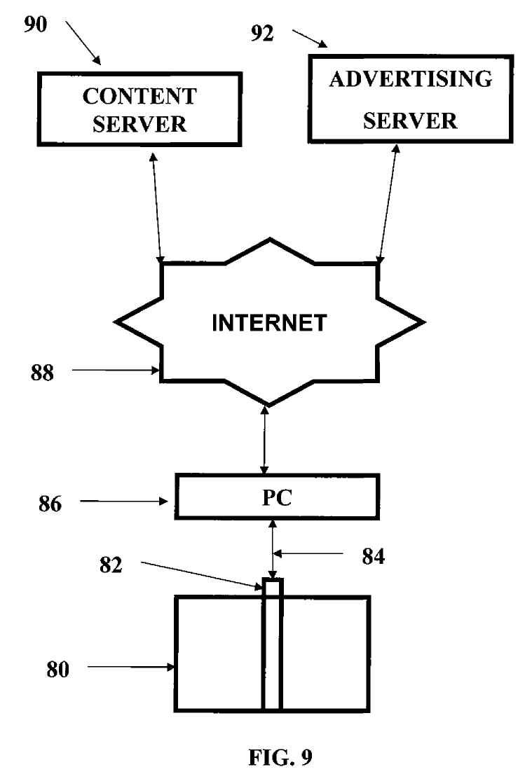

FIG. 9 illustrates another aspect of the present invention. A book 80 having a connection 82 to a computer 86 is illustrated. The connection 82 to the computer 86 is preferably a wireless transmitter and receiver. Alternatively, the connection to the computer 86 can be via a USB connector on the book and a memory on the book can supply the information supplied hereinafter.

The computer 86 is connected to one or more content servers 90 and one or more advertising servers 92 via an Internet connection 88.

The memory on the book 80 has information stored on it. In accordance with one aspect of the present invention, the information relates to the topic of the book. The information can be a program that is executed by the computer 86. The program has the web address for the server 90 or 92 being connected to and the computer 86, under control of the program on the storage media provided with the book 80, connects to the server under the program control.

In accordance with another aspect of the present invention, the server 90 or 92 downloads information stored on the server to the computer to be displayed by the computer. In the case of the content server 90, new content is downloaded from the server 90 to the computer 86 to be displayed on the computer 86. The new content is preferably related to the topic of the book 80 to enhance a reader's experience with the book 80. In the case of the advertising server 92, the new content downloaded from the advertising server 92 is advertisements. The advertisements preferably describe products or services related to the topic of the book 80.

The information stored on the server can be a list of a plurality of advertisements that can be selected for viewing. The list can be displayed on the computer 86 and one of the advertisements can be selected to be viewed on the computer 86. The advertisements stored on the server 92 can be periodically updated. Thus, advertisers wishing to update their advertisements can access the server 92 to store new advertisements on the server 92.

The advertisements stored on the server 92 can be pre-sold to manufacturers or service providers.

Of course, all of the information that is described as being on the servers 90 or 92 can be stored on memory on the book 80.

The item 80 can be any printed publication. Thus, the item 80 can be a hard cover book, a soft cover book, a pocket edition book or a magazine, or any other printed publication. The description provided above with respect to the book also applies to these printed media.

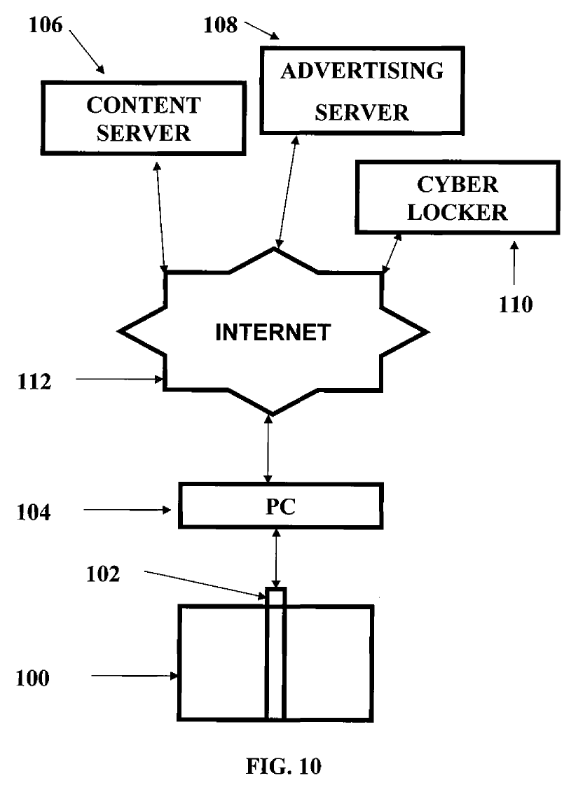

Referring now to FIG. 10, another aspect of the present invention is shown. A book 100 has a wireless connection 102 connected to a computer 104. The computer 104 is connected to advertising servers 106, content servers 108 and a user's cyber locker space 110 through the internet 112.

In accordance with another aspect of the present invention, the code on the book 100 or the other information provided on the book 100 can also provide access, in any of the previously described manners, to a site on the Internet that stores information relating to a person's personal memory space 110 on the internet 112. The space 110 is referred to as a Cyber Locker storage. This memory space is commonly provided to users of an internet service, but can also be part of a paid for service.

The information relating to a person's personal memory space 110 can include the web address of the memory space 110 on the internet 112. The information can also include a program that causes the computer 104 to query a user to enter the web address of the memory space 110.

A storage space on the Internet, related to the built out platform relating a person's personal memory space 110 can also include a cyber key that permits access to the personal memory space 110. The key can be specified by a user on the computer 104 and then stored on the platform for running the decoded hyperlinks. The key can be used by the computer 104 when accessing the personal memory space 110 to allow access to the personal memory space 110 by comparing the cyber key to a key stored by the personal memory space 110. If there is a match, then access is allowed.

The reader of the printed publication 100 can store information from the content server 108 or the advertising server 106 onto the personal memory space 110 on the internet 112. This can be done using the address information concerning the personal memory space 112 that is stored. Alternatively, the user can enter the information if it is not stored.

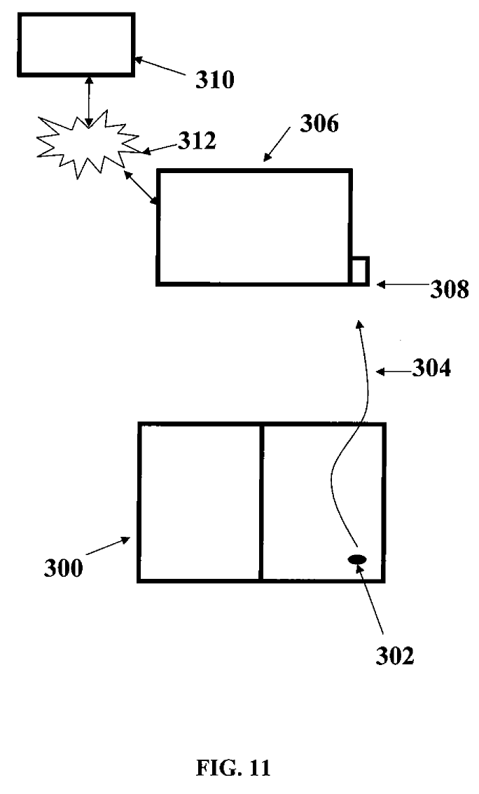

Referring to FIG. 11, a printed publication 300, such as a book, has an RFID tag 302 on it. The RFID tag 302 is shown on the front cover of the book 300 in FIG. 13, however, the RFID tag 302 can be located anywhere on the book 300.

RFID tags 302 typically communicate wirelessly and can be used, for example, to maintain inventories. Referring to FIG. 13, the RFID tag 302 sends a wireless signal 304 to a video or audio device 306. The video or audio device 306 receives the signal via a wireless interface 308. The video or audio device 306 can be any of the previously listed deices.

The RFID tag 302 has a memory on it. The memory on the RFID tag is typically small. In accordance with one aspect of the present invention, the memory stores an identification of the printed publication. In accordance with a further aspect of the present invention, the memory stores an address of an internet site. In accordance with yet another aspect of the present invention, the memory stores information related to the printed publication. The memory on the RFID tag 302 can store any combination of the above information.

In accordance with another aspect of the invention, the video or audio device is programmed to access an internet site 310 via the internet 312. The internet site has information related to the book 300 that can be accessed by the video or audio device 306. The video or audio device 306 is preferably programmed to read the signal 304 from the RFID tag 302, obtain the address of the site 310, and either provide access to the site 310 or automatically download information from the site 310 to the device 306.

The information on the RFID tag 302 could also be used to set up a Cyber Locker, as previously described herein. Additionally, any type of wireless transmission device that has a memory can be used.

A reader of the printed publication can be charged for information downloaded in accordance with the teachings of the present invention.

While it is true that education is definitely a purpose of the system and method of the present invention and, in fact, the book or printed publication of the present invention can be connected to a school server for continuing education and/or long distance learning, it can also be used for providing supplemental media information for any book or printed publication. For example, a book on Churchill might have his speeches, pictures of London, etc. stored on the memory to be played on a computer or other audio/video device, when the memory is connected thereto. As another example, a book on a sports legend may have video clips of some of his great plays etc. stored on the memory to be played on a computer or other audio/video device when the memory is connected thereto. Thus, the present invention can have plain recreational value.

As more examples. a book on Billie Holiday may store have a direct connection to I tunes and a connection to an IPod. The artist's music can be either downloaded to the IPod from the memory on a book, or can be downloaded from an internet site that is accessed.

Another example would be the ability to draw from audio chapters. This is an interesting case for a person who reads three chapters and then has an hour drive. That person might want to hear the next chapter 4 on the radio and then go back to reading chapter 5. With a connection through an Ipod either through a port connection or IR this would be possible and could even be played through a car's radio.

The extra cost could be charged as needed so listening to one chapter might be $0.50 as opposed to purchasing the whole book on tape. The ability to feed through a system that can electronically connect to it's own internal memory or the Internet is the key. It is important that every transmission need not be through the Internet. In the flash memory scenario the Internet was a single option, with the micro controller it is more necessary to gain access space and information. However, the information can be PRE Accessed. This is important if a person is going on an airplane and does not have access to the Internet. However, if he knows he is going on a plane and wants the information he can have the information transferred to the Cyber Locker ahead of time so that he is really drawing on the memory of the computer, much as he would draw on the memory of the flash, during this “outage”. This material could then be automatically updated to the Internet Cyber Locker” the next time communication was made. This is an important feature since it means that the book can always be used with a device without necessarily having Internet Connection.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A printed publication, comprising:
a plurality of pages; and
a readable code located on the printed publication, the readable code encoding an address to an Internet website.

2. The printed publication of claim 1, further comprising:
a reader that can read the readable code;
a transmitter that can transmit the readable code;
a receiver that can receive the readable code; and
a processing device that can use the readable code to access the Internet website.

3. The printed publication of claim 2, wherein the transmitter and receiver are wireless.

4. The printed publication of claim 1, wherein the readable code is a bar code.

5. The printed publication of claim 1, wherein the address is a hyperlink pointing to the Internet website.

6. The printed publication of claim 2, wherein the address is a hyperlink pointing to the Internet site and the processing device uses the hyperlink to access the Internet website.

7. The printed publication of claim 1, wherein the address points to one or more of a plurality of hyperlinks.

8. The printed publication of claim 2, wherein the address points to one of a plurality of hyperlinks in the processing device and the processing device uses the hyperlink to address the Internet website.

9. The printed publication of claim 8, wherein the plurality of hyperlinks are stored in a look up table.

10. The printed publication of claim 2, wherein the address points to two or more of a plurality of hyperlinks in the processing device and the processing device uses one of the hyperlinks to access the Internet.

11. The printed publication of claim 10, wherein the processing device displays a menu that is a function of the two or more of the plurality of hyperlinks and accesses the Internet based on a selection from the menu.

12. The printed publication of claim 1, further comprising a book or a magazine.

13. The printed publication of claim 1, further comprising one or more additional readable codes located on the printed publication.

14. The printed publication of claim 13, wherein the readable codes are located on a plurality of pages.

15. The printed publication of claim 1, the printed publication having a cover and the readable code being located on the cover.

16. The printed publication of claim 13, the plurality of pages being organized into a plurality of chapters, wherein each of the plurality of chapters has one of the readable codes associated with it.

17. The printed publication of claim 5, wherein the hyperlink points to advertising information.

18. The printed publication of claim 5, wherein the hyperlink points to educational information.

19. A method of conveying information from a printed publication having a plurality of pages, comprising providing a readable code located on the printed publication, the readable code encoding an address to an Internet website.

20. The method of claim 19, further comprising:
reading the readable code with a reader;
transmitting the readable code;
receiving the readable code at a processing device; and
using the readable code to access the Internet website.

21. The method of claim 20, wherein the transmitting and receiving are performed wirelessly.

22. The method of claim 19, wherein the readable code is a bar code.

23. The method of claim 19, wherein the address is a hyperlink pointing to the Internet website.

24. The method of claim 20, wherein the address is a hyperlink pointing to the Internet site and the processing device uses the hyperlink to access the Internet website.

25. The method of claim 19, wherein the address points to one or more of a plurality of hyperlinks.

26. The method of claim 20, wherein the address points to one of a plurality of hyperlinks in the processing device and the processing device uses the hyperlink to address the Internet website.

27. The method of claim 26, wherein the plurality of hyperlinks are stored in a look up table.

28. The method of claim 20, wherein the address points to two or more of a plurality of hyperlinks in the processing device and the processing device uses one of the hyperlinks to access the Internet.

29. The method of claim 28, wherein the processing device displays a menu that is a function of the two or more of the plurality of hyperlinks and accesses the Internet based on a selection from the menu.
